(19) United States
(12) Patent Application Publication
(10) Pub. No.: US 2009/0295757 A1
(43) Pub. Date: Dec. 3, 2009

(54) Multi-mode ultrasonic system

(76) Inventors: Xiaoying (Janet) He, Beijing (CN); Ying Jia, Beijing (CN)

Correspondence Address: Caven & Aghevli LLC;c/o CPA Global, P.O. BOX 52050, MINNEAPOLIS, MN, 55402, US

(21) Appl. No.: 10/585,156

(22) PCT Filed: Mar. 31, 2006
(86) PCT No.: PCT/CN06/00579

§ 371 Date: Jul. 7, 2009

(51) Int. Cl. G06F 3/043; G06F 3/033

(52) U.S. Cl. 345/177; 345/179

(57) ABSTRACT

In one embodiment, an apparatus comprises a switching mechanism to switch an input line between a first input voltage and a second input voltage, a pulse generator coupled to the switching mechanism to generate an electronic pulse train at a high frequency in response to the first input voltage and an electronic pulse train at a low frequency in response to the second input voltage, an oscillator circuit coupled to the pulse generator to receive the electronic pulse train, and an ultrasonic transmitter coupled to the oscillator circuit to produce an ultrasonic signal at a frequency that is a function of a frequency of the electronic pulse train.

### BACKGROUND

Ultrasonic (US) pen systems generally include a pen and a panel. A user may use the pen to write on the panel. The pen may generate ultrasonic signals which the panel digitizes and provides to a computer. Thus, the signals transmitted by the pen may be utilized by one or more applications to perform operations on information presented on the display.

Ultrasonic pen system may be used in multiple operating modes such as, e.g., a write mode and an erase mode. System designs that permit users to switch between operating modes would find utility.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 is a schematic illustration of a multi-mode ultrasonic system according to an embodiment.

FIG. 2 is a schematic illustration of aspects of an ultrasonic transmitting device according to an embodiment.

FIG. 3 is a flowchart illustrating operations executed by an operating mode module according to an embodiment.

FIG. 4 is a flowchart illustrating operations executed by an application according to an embodiment.

FIG. 5 is a schematic illustration of an ultrasonic system according to an embodiment.

FIG. 6 illustrate is a flowchart illustrating operations of a method to determine the location of an ultrasonic signal generator according to an embodiment.

FIG. 7 is a flowchart illustrating operations in a method to estimate the time difference of arrival (TDOA) of a pair signals according to an embodiment.

FIG. 8 is a schematic illustration of a multi-mode ultrasonic system according to an embodiment.

FIG. 9 is a schematic illustration of a computing system according to an embodiment.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention.

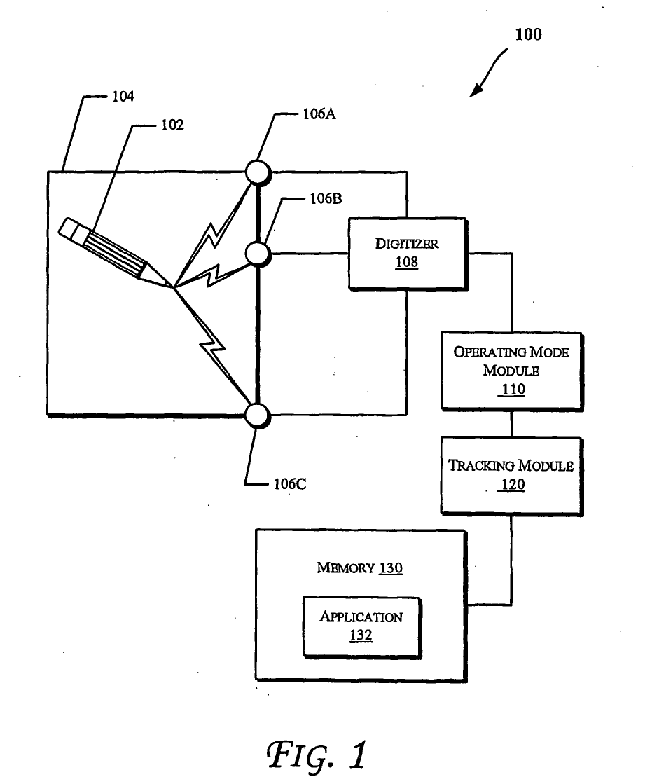

FIG. 1 is a schematic illustration of a multi-mode ultrasonic system according to an embodiment. Ultrasonic system 100 may include an ultrasonic transmitting device 102 that generates and transmits one or more ultrasonic signals. The ultrasonic transmitting device 102 may be any suitable device that includes one or more ultrasonic transducers to generate ultrasonic signals. For example, the ultrasonic transmitting device 102 may be embodied in a housing in the shape of a pen, such as illustrated in FIG. 1.

System 100 may further include an ultrasonic tracking assembly that includes one or more ultrasonic sensors (or receivers) 106 (e.g., 106A, 106B, 106C, etc.), a digitizer 108, an operating mode module 110, a tracking module 120, and a display panel 104. The sensors 106 may be any suitable ultrasonic sensor such as a microphone or the like. The sensors 106 may be coupled to digitizer 108 to convert the analog ultrasonic signals received by the sensors 106 (e.g., from the ultrasonic transmitting device 102) into digital format.

For example, digitizer 108 may include an analog to digital (A/D) converter, a signal sampling logic, or the like. Digitizer 108 may be implemented in any suitable location such as within the panel 104, within a computing device or the like. The digital signals from the digitizer 108 may be provided to an operating mode module 110 that utilizes one or more characteristics of the signal to determine an operating mode of the ultrasonic transmitting device 102 and a tracking module 120 that determines a location (or coordinates) of the ultrasonic transmitting device 102 based on the digital signals. The operating mode module 110 and the tracking module 120 may be provided as hardware, software, firmware, or combinations thereof in various embodiments. In one embodiment, tracking module 120 may use the time difference of arrival (TDOA) of the digital ultrasonic signals to determine (or estimate) the location of the ultrasonic transmitting device 102.

In embodiments, tracking module 120 may be coupled to a memory 130 that stores an application 132. Hence, the tracking module 120 may provide the location of the ultrasonic transmitting device 102 to the application 132. The location of the ultrasonic transmitting device 102 may be relative coordinates with respect to the panel 104 and/or the sensors 106. The application 132 may use the coordinates of the ultrasonic transmitting device 102 to manage user inputs.

The panel 104 may be any suitable panel such as a panel integrated in a computing device. Moreover, the panel 104 may be integrated in a tablet computing device, e.g., as the tablet (or screen) that a user may interact with. The panel 104 may also be a separate device that is coupled to a computing device via a bus. Ultrasonic transmitting device 102 may generate ultrasonic signals (e.g., when the tip of the pen (102) is pressed against, touches, or is in proximity to the panel 104). Hence, the ultrasonic transmitting device 102 may include one or more suitable ultrasonic transmitters (or transducers).

In one embodiment system 100 may utilize one or more characteristics of ultrasonic signals from an ultrasonic transmitting device to determine an operating mode for ultrasonic transmitting device 102. For example, in a first operating mode ultrasonic transmitting device 102 may be used to write on a panel 104, while in a second operating mode, ultrasonic transmitting device 102 may be used to erase on a panel. In one embodiment, a pulse frequency of the ultrasonic signal may be used to distinguish between a first operating mode and a second operating mode. In alternate embodiments other signal characteristics such as, e.g., an amplitude, a modulated pulse frequency, or the like may be used to distinguish between operating modes.

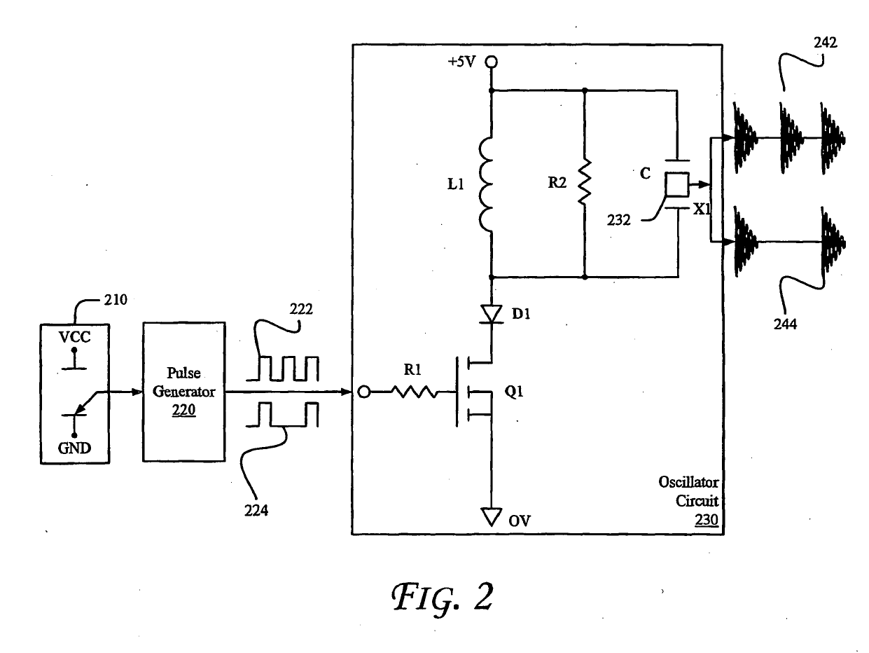

FIG. 2 is a schematic illustration of aspects of an ultrasonic transmitting device 102 according to an embodiment. Referring to FIG. 2, ultrasonic transmitting device 102 may include a switching mechanism 210 that permits an input line to be switched between a first input voltage and a second input voltage. In the embodiment depicted in FIG. 2, the first input voltage may correspond to VCC and the second input voltage may correspond to ground (GND). VCC may be a function of the design of circuitry in the ultrasonic transmitting device. In one embodiment switching mechanism may be embodied as a toggle switch in the housing of ultrasonic transmitting device. In alternate embodiments, switching mechanism 210 may be implemented as a digital switch, or the like.

The input voltage from switching mechanism is directed to a pulse generator 220, which generates an electronic pulse in response to the input voltage. In one embodiment, pulse generator 220 may be embodied as a microcontroller unit (MCU). In one embodiment, pulse generator 220 generates a high-frequency digital pulse train 222 in response to a high input voltage such as, e.g., VCC, and a low frequency digital pulse train 224 in response to a low input voltage such as, e.g., GND. In alternate embodiments pulse generator 220 generates a low-frequency digital pulse train 222 in response to a high input voltage such as, e.g., VCC, and a high frequency digital pulse train 224 in response to a low input voltage such as, e.g., GND. Thus, changing the input voltage at switching mechanism causes a corresponding change in the frequency of the electronic pulse train from pulse generator 220.

The electronic pulse train from pulse generator 220 is input to an oscillator circuit 230. In one embodiment, oscillator circuit 230 may be implemented as a parallel RLC circuit that drives an ultrasonic transmitter 232. Ultrasonic transmitter 232 generates an ultrasonic signal in response to the frequency oscillator circuit. In one embodiment, ultrasonic transmitter 232 produces an ultrasonic signal 242 having a high pulse frequency in response to a high-frequency electronic pulse train 222 and an ultrasonic signal 244 having a low pulse frequency in response to a low-frequency electronic pulse train 224. In an alternate embodiment, ultrasonic transmitter 232 produces an ultrasonic signal 244 having a low pulse frequency in response to a high-frequency electronic pulse train 222 and an ultrasonic signal 242 having a high pulse frequency in response to a low-frequency electronic pulse train 224.

Referring back to FIG. 1, the ultrasonic signal 242, 244 produced by ultrasonic transmitter 232 is received by one or more of the sensors 106A, 106B, 106C, which generate an electrical signal that is a function of the received ultrasonic signal 242, 244. The electrical signals generated by one or more of sensors 106A, 106B, 106C may be input to a digitizer 108, which digitizes the signals. The digitized signals maintain information about the pulse frequency of the ultrasonic signal 242, 244 received by one or more of the sensors 106A, 106B, 106C. Optionally, digitizer 108 may combine the electrical signals into a composite signal.

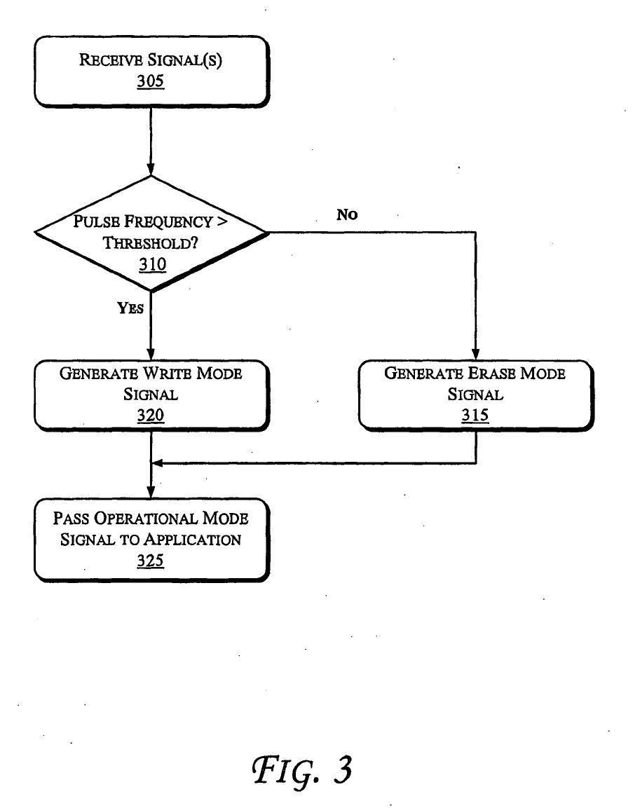

The digitized signal(s) from digitizer 108 are input to an operating mode module 110, which generates a signal that is a function of the pulse frequency of the received ultrasonic signal 242, 244. FIG. 3 is a flowchart illustrating operations executed by operating mode module 110, according to an embodiment. Referring to FIG. 3, at operation 305 the operating mode module 110 receives one or more signals from the digitizer 108. If, at operation 310, the signal(s) from digitizer 108 indicate that the pulse frequency of the received ultrasonic signal 242, 244 is not greater than a threshold, then control passes to operation 315 and operating mode module 110 generates a signal that indicates that the ultrasonic transmitter is operating in an erase mode. By contrast, if at operation 310 the signal(s) indicate that the pulse frequency of the received ultrasonic signal 242, 244 is greater than a threshold, then control passes to operation 320 and operating mode module 110 generates a signal that indicates that the ultrasonic transmitter is operating in write mode. At operation 325 the signal generated by operating mode module 110 is passed to an application 132.

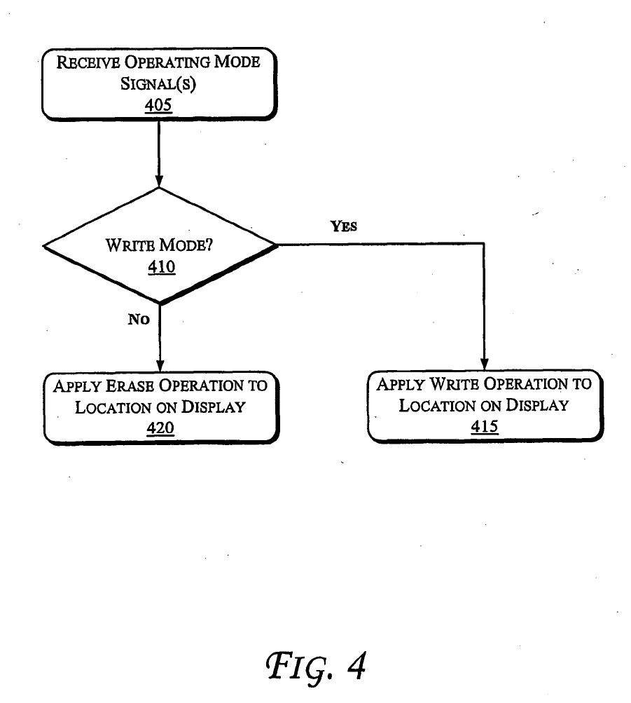

In one embodiment, application 132 may use the operating mode indicator signal generated by operating mode module to select an operation to be executed on the display 104. FIG. 4 is a flowchart illustrating operations executed by application 132, according to an embodiment. Referring to FIG. 4, at operation 405 the application 132 receives one or more operating mode signals from the operating mode module 110. If, at operation 410, the signal(s) from operating mode module 110 indicate that the transmitter is operating in write mode, then control passes to operation 415 and operating mode module 110 applies a write operation to a location on the display 104. By contrast, if at operation 410 the signal(s) from from operating mode module 110 indicate that the transmitter is operating in erase mode, then control passes to operation 420 and operating mode module 110 applies an erase operation to a location on the display 104.

Referring back to FIG. 1, in one embodiment the system 100 includes a tracking module 120 to determine the location of ultrasonic transmitting device 102 in relation to the display 104. In one embodiment the tracking module 120 utilizes the time difference of arrival (TDOA) of the ultrasonic signals collected by sensors 106A, 106B, 106C to determine (or estimating) the location (or coordinates) of the ultrasonic transmitting device 102.

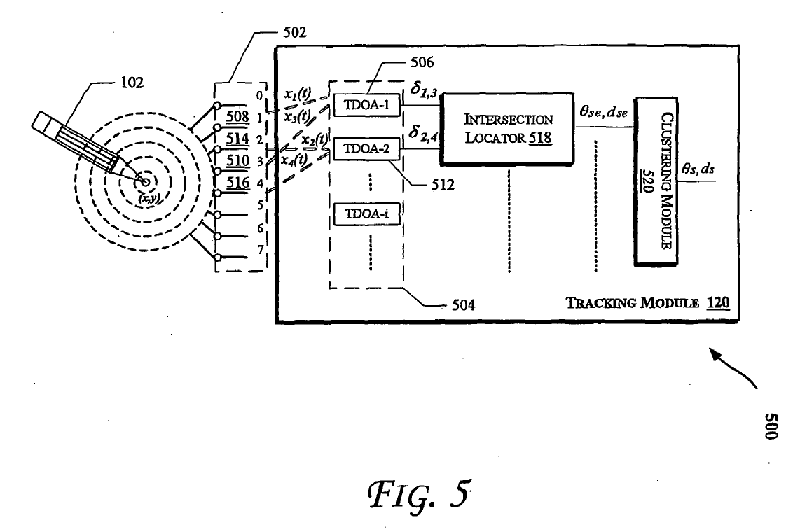

FIG. 5 is a schematic illustration of an embodiment of an ultrasonic tracking system 500 according to an embodiment. The system 500 may include the ultrasonic signal generator 102 and an array of ultrasonic receivers 502 to receive the generate ultrasonic signals. The array of ultrasonic receivers 502 may correspond to the receivers 106A, 106B, 106C in the embodiment depicted in FIG. 1. As discussed with reference to FIG. 1, the ultrasonic signals from the ultrasonic signal generator 102 may be digitized (e.g., by the digitizer 108) prior to providing the signals to a tracking module 120. Furthermore, the array 502 may digitize the generated ultrasonic signals in an embodiment.

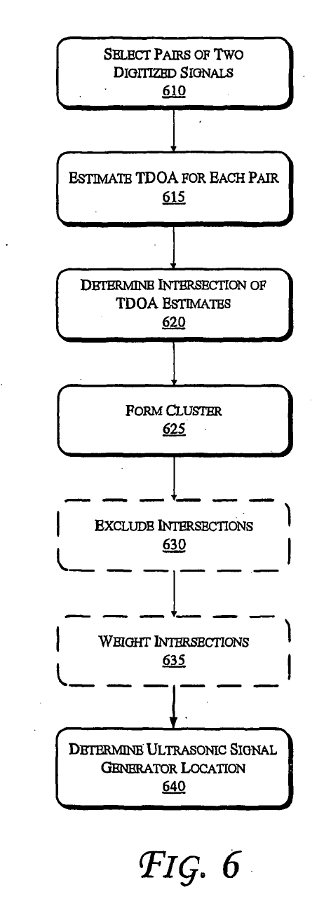

FIG. 6 is a flowchart illustrating operations executed by tracking module 120, according to an embodiment. Referring to FIG. 6, at operation 610 a plurality of pairs of the digitized ultrasonic signals from digitizer 108 may be selected (e.g., from at least three of the sensors in the array 502). Hence, the plurality of selected pairs may be used to form two or more pairs of digital ultrasonic signals. For example, the tracking module 120 may include one or more TDOA modules 504 (such as 506 and 508). The TDOA modules 504 may perform operation 610 in an embodiment. For instance, the TDOA module 506 may select the signals from a pair of receivers (e.g., 508 and 510) and the TDOA module 512 may select the signals from another pair of receivers (e.g, 514 and 516).

At operation 615, the time difference of arrival (TDOA) of each of the pairs of the stage 506 are estimated (e.g., by the TDOA modules 204). At operation 620 the intersection of each pair of the TDOA estimated digital ultrasonic signals are determined, e.g., by one or more intersection locator(s) 518. At operation 625 a clustering module 520 may utilize a plurality of the intersections to form a cluster. In one embodiment, the clustering module 520 may optionally exclude (operation 630) one or more of the intersections from the cluster, e.g., because the excluded intersection(s) are more than a threshold distance from other members of the cluster. In an optional operation 635, the clustering module 520 may weight the intersections in the cluster according to the distance between the ultrasonic transmitting device 102 and the respective receiver (502). Hence, the closer receivers may render a more accurate result and may be weighted higher.

At operation 640, the location (or coordinates) of the ultrasonic transmitting device 102 is determined which corresponds to at least one of the intersections. In one embodiment, the center of the cluster may be selected as the location of the ultrasonic transmitting device 102. In one embodiment, the method may be utilized for any ultrasonic pen, e.g., since any ultrasonic signal generated by an ultrasonic transmitting device (102) may be utilized to determine the location of the ultrasonic transmitting device (102).

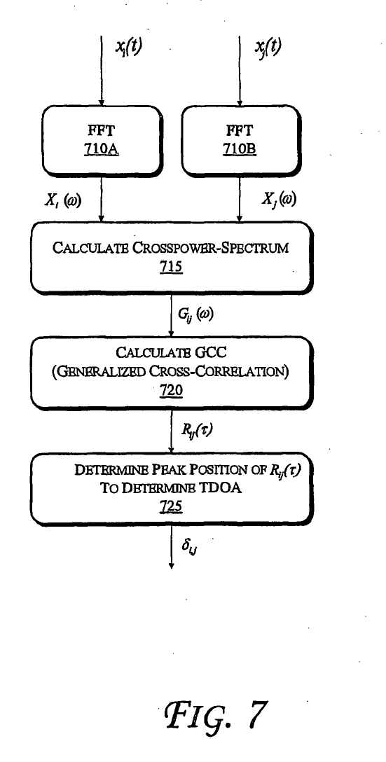

FIG. 7 is a flowchart illustrating operations in a method to estimate the time difference of arrival (TDOA) of a pair signals. In one embodiment, the method may be utilized to perform the stage 615 of FIG. 6. Furthermore, each of the TDOA modules 504 of FIG. 5 (e.g., modules 506 and/or 512) may be utilized to perform the stages of the method.

The stages 710A and 710B calculate the fast Fourier transform (FFT) of a pair of digital ultrasonic signals according to the following:

Xᵢ(ω)=∫xᵢ(t)e^{-jwt}dt

where Xᵢ(ω) is the FFT, xᵢ(t) is the digital ultrasonic signal, jw is the frequency element at w, and t is time.

At the stage 715, the crosspower-spectrum of the pair from the stages 502 and 504 is calculated as follows:

Gᵢⱼ(ω)=Xᵢ(ω)·Xⱼ^{H}(ω)

where Xⱼ^{H}(ω) is the conjugate version of Xᵢ(ω).

At a stage 720, the generalized cross-correlation (GCC) of the crosspower-spectrum of the stage 506 is calculated as follows:

Rᵢⱼ(τ)=∫W(ω)Gᵢⱼ(ω)e^{jwt}dω

In an embodiment, the weighting function W (ω) may be any suitable weighting function, such as ML (maximum likelihood), PHAT (phase transform), modified PHAT criterion, or the like. In some embodiments, ML may be sensitive to reverberation and/or non-stationary noise. Since PHAT is less sensitive to reverberation, the modified PHAT criterion may be selected as the weighting function where potential for reverberation and/or non-stationary noise may be present.

At a stage 725 the peak position of the GCC of the stage 508 is determined to determine the TDOA as follows:

$${δ}_{ij} = {arg max}_{r} {R}_{ij} ( τ )$$

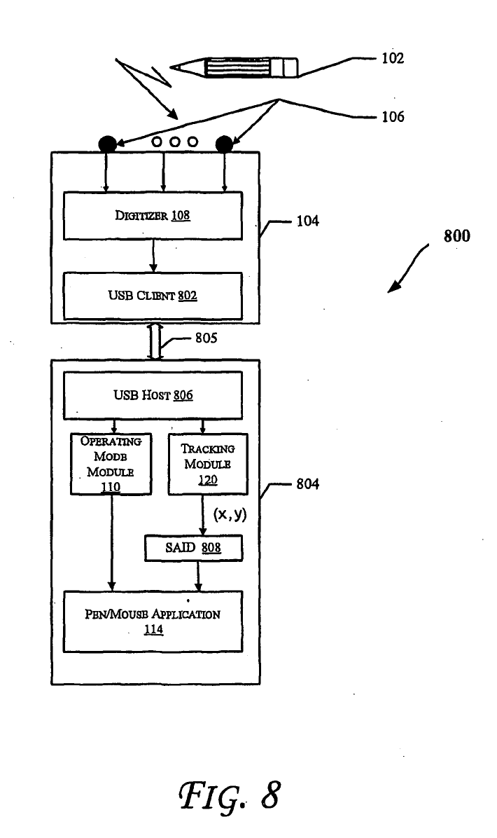

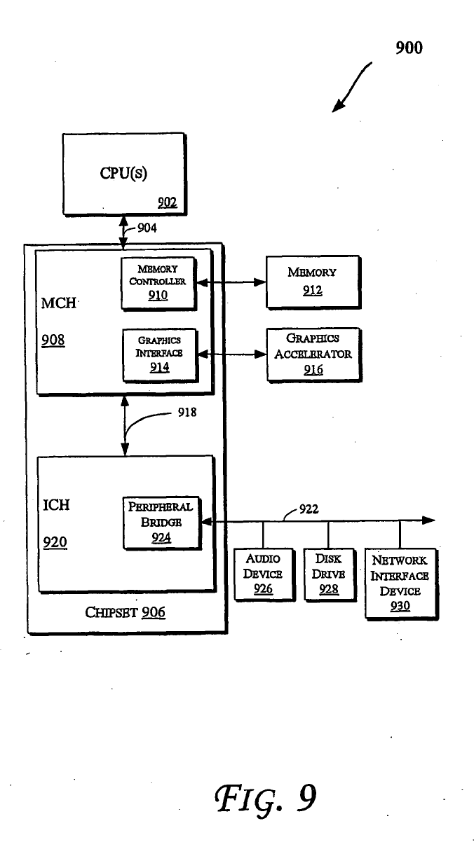

FIG. 8 is a schematic illustration of an embodiment of a multi-mode ultrasonic system 800. The system 800 may determine an operating mode of the ultrasonic transmitting device, track the location of the ultrasonic transmitting device 102 relative to the panel 104, and apply an operation to the location on the panel 104 based on the operating mode of the transmitting device 102. The one or more ultrasonic sensors (or receivers) 106 receive the generated ultrasonic signals and provide them to the digitizer 108. As discussed with reference to FIG. 1, the digitizer 108 may include an A/D converter, a signal sampling logic, or the like. An A/D converter of the digitizer 108 may be utilized to convert the analog ultrasonic signals to digital format. The digital ultrasonic signals may be provided to a universal serial bus (USB) client 802 to be communicated to a host-based driver 804 through a USB bus 805. Other bus topologies may also be utilized such as those discussed with reference to bus 922 of FIG. 9.

The bus 805 may be coupled to a USB host 806 of the driver 804 to receive the digital ultrasonic signals and provide them to the operating mode module 110 and the tracking module 120. In an embodiment, the operating mode module 110 and the tracking module 120 may be embodied as described above. The operating mode The tracking module 120 determines the location (or coordinates) of the ultrasonic transmitting device 202 and provides the location to a standard audio input device (SAID) 808. The SAID 808 may support some pen/mouse applications (114) without any change. For example, the location may be provided to a standard interface (SAID 808) and follow that interface for application (114) call-backs. As discussed with reference to FIG. 1, the coordinates of the ultrasonic transmitting device 102 may be directly provided to the application 114.

FIG. 9 illustrates a block diagram of a computing system 900 in accordance with an embodiment of the invention. The computing system 900 may include one or more central processing units) (CPUs) 902 or processors coupled to an interconnection network (or bus) 904. The processors (902) may be any suitable processor such as a general purpose processor, a network processor, or the like (including a reduced instruction set computer (RISC) processor or a complex instruction set computer (CISC)). Moreover, the processors (902) may have a single or multiple core design. The processors (902) with a multiple core design may integrate different types of processor cores on the same integrated circuit (IC) die. Also, the processors (902) with a multiple core design may be implemented as symmetrical or asymmetrical multiprocessors.

A chipset 906 may also be coupled to the interconnection network 904. The chipset 906 may include a memory control hub (MCH) 908. The MCH 908 may include a memory controller 910 that is coupled to a memory 912. The memory 912 may store data and sequences of instructions that are executed by the CPU 902, or any other device included in the computing system 900. In one embodiment of the invention, the memory 912 may include one or more volatile storage (or memory) devices such as random access memory (RAM), dynamic RAM (DRAM), synchronous DRAM (SDRAM), static RAM (SRAM), or the like. Nonvolatile memory may also be utilized such as a hard disk. Additional devices may be coupled to the interconnection network 904, such as multiple CPUs and/or multiple system memories.

The MCH 908 may also include a graphics interface 914 coupled to a graphics accelerator 916. In one embodiment of the invention, the graphics interface 914 may be coupled to the graphics accelerator 916 via an accelerated graphics port (AGP). In an embodiment of the invention, a display (such as a flat panel display) may be coupled to the graphics interface 914 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 918 may couple the MCH 908 to an input/output control hub (ICH) 920. The ICH 920 may provide an interface to input/output (I/O) devices coupled to the computing system 900. The ICH 920 may be coupled to a bus 922 through a peripheral bridge (or controller) 924, such as a peripheral component interconnect (PCI) bridge, a universal serial bus (USB) controller, or the like. The bridge 924 may provide a data path between the CPU 902 and peripheral devices. Other types of topologies may be utilized. Also, multiple buses may be coupled to the ICH 920, e.g., through multiple bridges or controllers. Moreover, other peripherals coupled to the ICH 920 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or the like.

The bus 922 may be coupled to an audio device 926, one or more disk drive(s) 928, and a network interface device 930. Other devices may be coupled to the bus 922. Also, various components (such as the network interface device 930) may be coupled to the MCH 908 in some embodiments of the invention. In addition, the CPU 902 and the MCH 908 may be combined to form a single chip. Furthermore, the graphics accelerator 916 may be included within the MCH 908 in other embodiments of the invention.

Additionally, the computing system 900 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 928), a floppy disk, a compact disk ROM (CD-ROM), a digital versatile disk (DVD), flash memory, a magneto-optical disk, or other types of nonvolatile machine-readable media suitable for storing electronic instructions and/or data.

Thus, described herein are systems and methods for a multi-mode ultrasonic system in which the operating mode of the system may be set at the ultrasonic transmitting device 102, e.g., by altering one or more characteristics of the ultrasonic signal emitted by the ultrasonic transmitting device 102. In one embodiment the pulse frequency of the ultrasonic signal may be set to a first frequency to implement a write operation and a second frequency to implement an erase operation. The particular frequencies of the settings are not critical. In one embodiment the write mode may be set to a relatively higher frequency than the erase mode, which reduces power consumption. For example, in write mode the ultrasonic transmitter 102 may transmit an ultrasonic signal at a frequency in the range of 60-80 Hz, while in the erase mode the ultrasonic transmitter may transmit an ultrasonic signal at a frequency in the range of 30-40 Hz. Alternate embodiments may permit three or more modes of operation by varying signal characteristics in three or more distinct fashions. In addition, alternate embodiments may vary signal characteristics other than the pulse frequency such as e.g., the amplitude, the modulated pulse frequency, or the like.

In various embodiments, one or more of the operations discussed herein, e.g., with reference to FIGS. 1-9, may be implemented as hardware (e.g., logic circuitry), software, firmware, or combinations thereof, which may be provided as a computer program product, e.g., including a machine-readable or computer-readable medium having stored thereon instructions used to program a computer to perform a process discussed herein. The machine-readable medium may include any suitable storage device such as those discussed with reference to FIGS. 1 and 9.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with that embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a switching mechanism to switch an input line between a first input voltage and a second input voltage;
a pulse generator coupled to the switching mechanism to generate an electronic pulse train at a high frequency in response to the first input voltage and an electronic pulse train at a low frequency in response to the second input voltage;
an oscillator circuit coupled to the pulse generator to receive the electronic pulse train; and
an ultrasonic transmitter coupled to the oscillator circuit to produce an ultrasonic signal at a frequency that is a function of a frequency of the electronic pulse train.

2. The apparatus of claim 1, further comprising a housing, and wherein the switching mechanism comprises a toggle switch moveable between a first position corresponding to the first input voltage and a second position corresponding to the second input voltage.

3. The apparatus of claim 2, wherein the pulse generator comprises a microcontroller unit that generates a digital pulse train.

4. The apparatus of claim 3, wherein the switching mechanism connects the microcontroller unit to a high voltage input when set in the first position and to a low voltage input when set in the second position.

5. The apparatus of claim 1, wherein:
the ultrasonic transmitter generates an ultrasonic signal at a high frequency in response to a high frequency electronic pulse train; and
the ultrasonic transmitter generates an ultrasonic signal at a low frequency in response to a low frequency electronic pulse train.

6. A system comprising:
an ultrasonic transmitting device, comprising an ultrasonic transmitter to produce an ultrasonic signal at one of a first frequency or a second frequency; and
an ultrasonic tracking device, comprising:
one or more ultrasonic receivers to receive the ultrasonic signal;
a frequency detector to generate a mode indicator signal that is a function of a frequency of the ultrasonic signal.

7. The system of claim 6, wherein the ultrasonic transmitting device further comprises:
a pulse generator to generate an electronic pulse train;
a switching mechanism coupled to the pulse generator to switch the logic between a first operating mode that produces an electronic pulse train at a high frequency and a second operating mode that produces an electronic pulse train at a low frequency; and
an oscillator circuit coupled to the pulse generator to receive the digital pulse train.

8. The system of claim 7, wherein:
the ultrasonic transmitter generator generates an ultrasonic signal at a high frequency in response to a high frequency electronic pulse train; and
the ultrasonic transmitter generates an ultrasonic signal at a low frequency in response to a low frequency electronic pulse train.

9. The system of claim 6, wherein the frequency detector generates a first mode indicator signal in response to an ultrasonic signal at a high frequency and a second mode indicator signal in response to an ultrasonic signal at a low frequency.

10. The system of claim 7, further comprising a computing device coupled to the ultrasonic tracking device, wherein the computing device comprises:
a processor;
a memory module comprising logic instructions which, when executed, configure the processor to:
receive the mode indicator signal from the ultrasonic tracking device; and
use the mode indicator signal to process one or more additional signals from the ultrasonic transmitting device.

11. The system of claim 10, further comprising:
a display; and
logic instructions which, when executed, configure the processor to:
locate a position on the display using information in the ultrasonic signal; and
apply an erase operation to the position on the display device in response to a first mode indicator signal.

12. The system of claim 10, further comprising:
a display; and
logic instructions which, when executed, configure the processor to:
locate a position on the display using information in the ultrasonic signal; and
apply a write operation to the position on the display device in response to a second mode indicator signal.

13. The system of claim 10, further comprising logic instructions which, when executed, configure the processor to:
select a plurality of pairs of digital ultrasonic signals to form two or more pairs of digital ultrasonic signals;
estimate time difference of arrival (TDOA) for each of the two or more pairs of digital ultrasonic signals;
determine an intersection of each pair of the TDOA estimated digital ultrasonic signals to form one or more intersections; and
determine a location of an ultrasonic signal generator corresponding to at least one of the one or more intersections.

14. A method comprising:
transmitting, from a first device, an ultrasonic signal at one of a high frequency or a low frequency; and
receiving, at a second device, the ultrasonic signal;
generating a mode indicator signal that indicates whether the ultrasonic signal is at the high frequency or the low frequency; and
using the mode indicator signal to process one or more additional ultrasonic signals from the first device.

15. The method of claim 14, wherein transmitting, from a first device, an ultrasonic signal at one of a first frequency or a second frequency comprises:
setting a switching mechanism to one of a first operating mode that generates an electronic pulse train at a high frequency and a second operating mode that generates an electronic pulse train at a low frequency; and
directing the electronic pulse train to an ultrasonic transmitter coupled to an oscillator circuit.

16. The method of claim 15, wherein
the ultrasonic transmitter generates an ultrasonic signal at a high frequency in response to a high frequency electronic pulse train; and
the ultrasonic transmitter generates an ultrasonic signal at a low frequency in response to a low frequency electronic pulse train.

17. The method of claim 14, wherein using the mode indicator signal to process one or more additional ultrasonic signals from the first device comprises:
locating a position on the display using information in the ultrasonic signal; and
applying an erase operation to the position on the display device in response to a first mode indicator signal.

18. The method of claim 17, wherein locating a position on the display using information in the ultrasonic signal comprises:
selecting a plurality of pairs of digital ultrasonic signals to form two or more pairs of digital ultrasonic signals;
estimating time difference of arrival (TDOA) for each of the two or more pairs of digital ultrasonic signals;
determining an intersection of each pair of the TDOA estimated digital ultrasonic signals to form one or more intersections; and
determining a location of an ultrasonic signal generator corresponding to at least one of the one or more intersections.

19. The method of claim 14, wherein using the mode indicator signal to process one or more additional ultrasonic signals from the first device comprises:
locating a position on the display using information in the ultrasonic signal; and
applying an erase operation to the position on the display device in response to a second mode indicator signal.

20. The method of claim 19, wherein locating a position on the display using information in the ultrasonic signal comprises:
selecting a plurality of pairs of digital ultrasonic signals to form two or more pairs of digital ultrasonic signals;
estimating time difference of arrival (TDOA) for each of the two or more pairs of digital ultrasonic signals;
determining an intersection of each pair of the TDOA estimated digital ultrasonic signals to form one or more intersections; and
determining a location of an ultrasonic signal generator corresponding to at least one of the one or more intersections.
